(19) United States
(12) Patent Application Publication
(10) Pub. No.: US 2012/0312809 A1
(43) Pub. Date: Dec. 13, 2012

(54) MICROWAVE OVEN

(76) Inventors: Shouguo WANG, Guangdong (CN); Zhigang Li, Guangdong (CN); Zongyin Ou, Guangdong (CN); Deqiang Tan, Guangdong (CN)

(21) Appl. No.: 13/591,041

(22) Filed: Aug. 21, 2012

Related U.S. Application Data
(63) Continuation of application No. PCT/CN2011/071228, filed on Feb. 24, 2011.

(30) Foreign Application Priority Data
Mar. 29, 2010 (CN) 201010140548.8

(51) Int. Cl. H05B 6/64

(52) U.S. Cl. 219/756

(57) ABSTRACT

A microwave oven includes an oven seat, an oven cover hinged on the oven seat and a cooking chamber enclosed by the oven seat and oven cover. The oven cover comprises, in this order from an inner side to an outer side, a waterproof cover, a microwave shielding cover and an outer cover that are formed respectively in a hemispherical shape and assembled together via an oven cover skeleton and a skeleton frame. The oven cover skeleton includes an annular base body with an assembly groove to allow the waterproof cover to be wedged therein. The waterproof cover has a first flange to be wedged in the assembly groove. The microwave shielding cover has a second flange to be pressed on the base body. The skeleton frame is coupled on the outer side of the microwave shield cover and pressed on the second flange and oven cover skeleton.

This application is a continuation of International Application No. PCT/CN2011/071228 filed on Feb. 24, 2011 for which priority is claimed under 35 U.S.C. §120; and this application claims priority of Application No. 201010140548.8 filed in China on Mar. 29, 2010, for which priority is claimed under 35 U.S.C. §119, the entire contents of all of which are hereby incorporated by reference.

### FIELD OF THE INVENTION

The present invention relates to a microwave oven.

### BACKGROUND OF THE INVENTION

A conventional microwave oven, referring to FIG. 1, usually is formed in the shape of a chest including a box-shaped cooking chamber 21, a panel-like door 22 and an electrical facility room at one side of the cooking chamber 21. It also has an oven chamber formed by a metal enclosure to hold a magnetic control tube 20 at a lateral side thereof. The magnetic control tube 20 emit microwave from the lateral side of the oven chamber into the oven chamber. Such type of microwave oven structure is constrained by the chest shape, hence utilization efficiency of the cooking chamber 21 is not desirable. As total size of the microwave oven is restricted, the size of the cooking chamber 21 also cannot be made as big as desired. Moreover, with the door 22 located at the front side of the cooking chamber 22, loading and unloading foods is not convenient.

China patent No. CN2898661Y issued on May 9, 2007 discloses a microwave which comprises a housing, a window, a door with a mask window and a handle on the door. The housing and inner wall of the microwave are formed respectively in a hemispherical shape. Such a structure saves space, but it still has a door on the hemispherical oven body.

Japan publication No. 2003-83548A discloses a heating cooking apparatus. It has a body, a lid to cover the body on the top and a cooking chamber located therebetween. The lid is divided into multiple sets, and at least one of them can be opened or closed. When the heating cooking apparatus is in the open condition, the lids are overlapped and cannot be fully opened. Hence loading and unloading foods is difficult. Moreover, in terms of shielding the microwave, multiple sets of lids make fabrication more difficult.

### SUMMARY OF THE INVENTION

It is an object of the present invention to provide a microwave oven that is simply structured, flexibly operated, fabricated at lower cost, securely coupled and safer, and also has improved cooking compartment utilization to overcome the deficiency of the conventional techniques.

To achieve the foregoing object, the microwave oven according to the invention includes an oven seat, an oven cover hinged on the oven seat and a cooking chamber enclosed by the oven seat and oven cover. The oven cover includes, in this order from an inner side to an outer side, a waterproof cover, a microwave shielding cover and an outer cover that are formed respectively in a hemispherical shape and assembled together through an oven cover skeleton and a skeleton frame.

The oven cover skeleton includes an annular base body which has an assembly groove on an inner side. The waterproof cover is wedged in the assembly groove. The microwave shielding cover is pressed on the base body.

The waterproof cover has a first flange on the outer rim thereof to be wedged in the assembly groove. The microwave shielding cover has a second flange on the outer rim thereof to be pressed on the base body.

The skeleton frame is coupled on an outer side of the microwave shielding cover and pressed on the second flange and oven cover skeleton.

The skeleton frame has an annular holding groove wedged by the outer rim of the outer cover.

The second flange of the microwave shielding cover is coupled by a compressed ring which allows the second flange to be fastened tightly via screws to the oven cover skeleton.

The base body of the oven cover skeleton has at least one choke groove on the outer side thereof.

The oven cover has a shielding plate embedded in the outer side of the oven cover skeleton.

The oven seat and oven cover are latched by at least one door lock mechanism which includes a latch bolt, a latch hook, a spring, a press blade and a door lock pushbutton installed on the oven seat. The latch bolt is located on the oven cover skeleton. The latch hook has one end extended outwards from an upper end surface of the oven seat and another end connected to the spring fastened to the oven seat. The press blade is fastened to the oven seat and has two ends connected respectively to the latch hook and door lock pushbutton.

The waterproof cover and outer cover are transparent and made of a non-metal material. The shielding plate has a latch hole corresponding to the latch bolt. The oven seat has a control panel on a flange at one side thereof. The door lock pushbutton is located on one side of the control panel. The oven seat also has a protective cover. The latch hook is located in the protective cover.

The invention, by assembling the oven cover onto the oven seat, forms a hemispherical cooking chamber, hence can facilitate reflection and transmission of microwaves in the cooking compartment and improve utilization thereof. All electric elements are located below the cover seat, thus the space of the cooking compartment above the oven seat can be maximized to facilitate cooking of foods. The entire oven cover serves as a door of the microwave oven and can be fully open, rather than opened one half or partially, hence foods can be loaded and unloaded easily. The oven cover and the oven seat at the lower side can be closed together to achieve desired microwave shielding. All this can reduce production cost and improve production efficiency.

The microwave oven of the invention thus formed provides many benefits, such as simplified structure, flexible operation, lower fabrication cost, secure coupling and enhanced safety, and also greatly improves utilization of the cooking compartment.

The foregoing, as well as additional objects, features and advantages of the invention will be more readily apparent from the following detailed description, which proceeds with reference to the accompanying drawings.

### BRIEF DESCRIPTION OF THE DRAWINGS

FIG. 1 is a schematic view of a conventional microwave oven.

FIG. 2 is a schematic view of a first embodiment of the invention.

FIG. 3 is an exploded view of the oven cover.

FIG. 4 is a cross section of the oven cover after assembled.

FIG. 5 is a schematic enlarged view on spot C in FIG. 4.

FIG. 6 is a schematic enlarged view on spot A in FIG. 2.

FIG. 7 is a perspective view of the invention in an open condition.

FIG. 8 is a schematic enlarged view on spot B in FIG. 7.

FIG. 9 is a fragmentary sectional view of the invention in a closed condition.

FIG. 10 is a perspective view of the oven seat.

FIG. 11 is a fragmentary sectional view of the oven seat.

### DETAILED DESCRIPTION OF THE PREFERRED EMBODIMENT

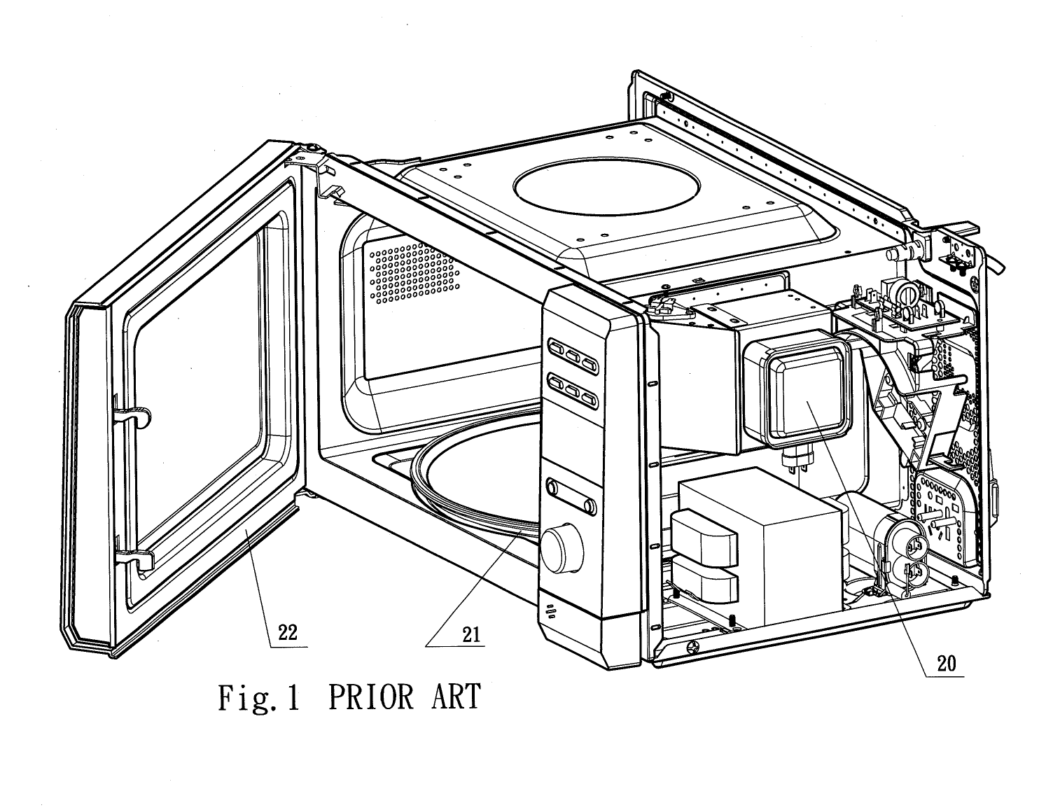

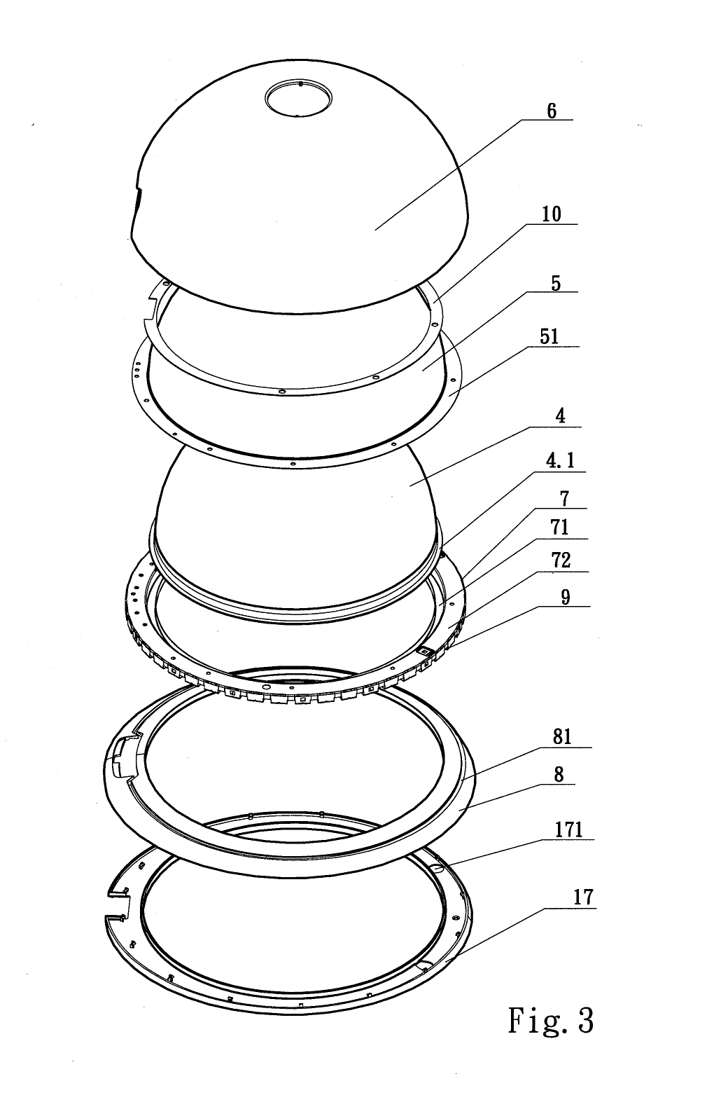

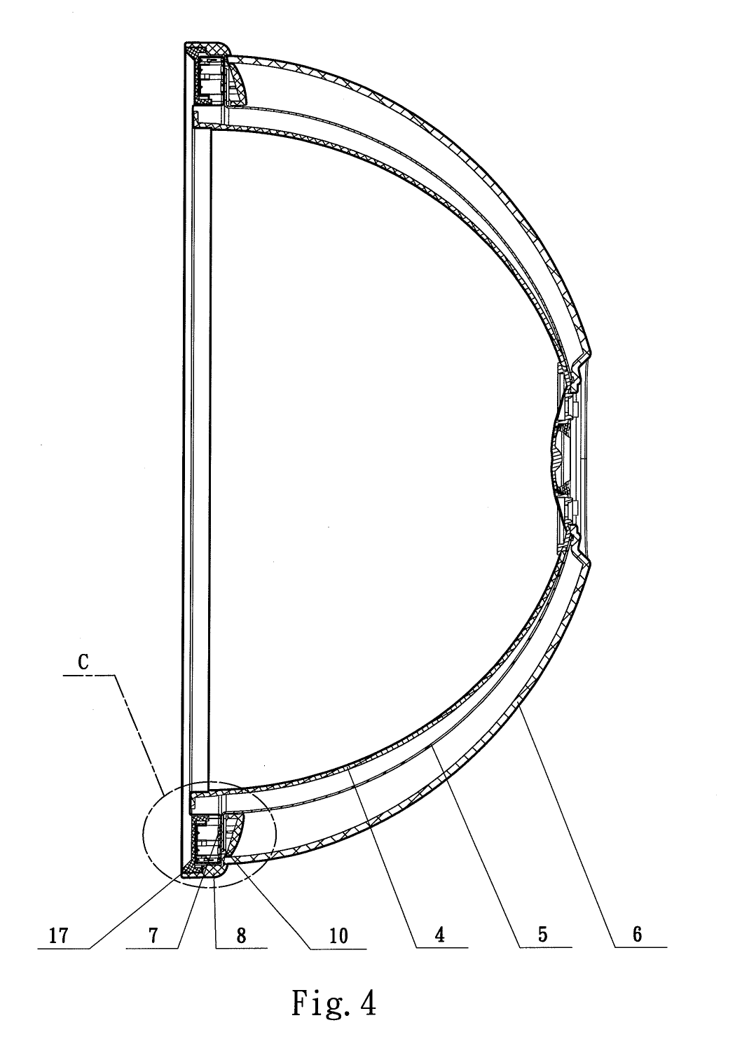

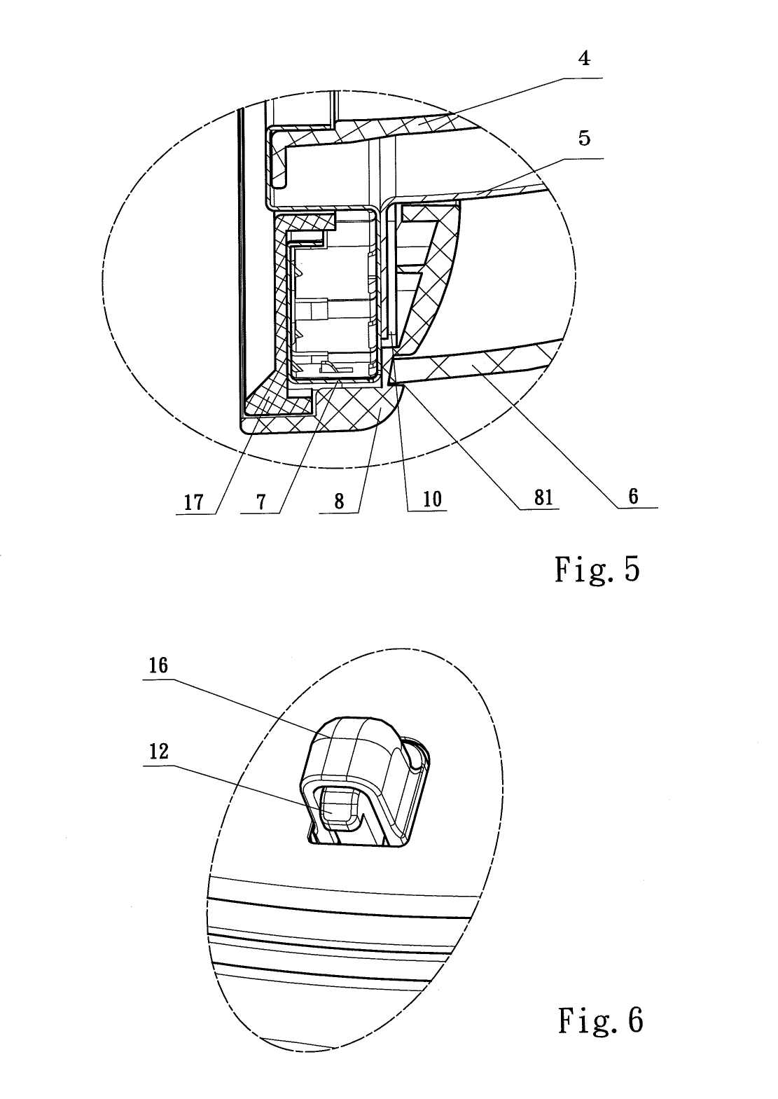

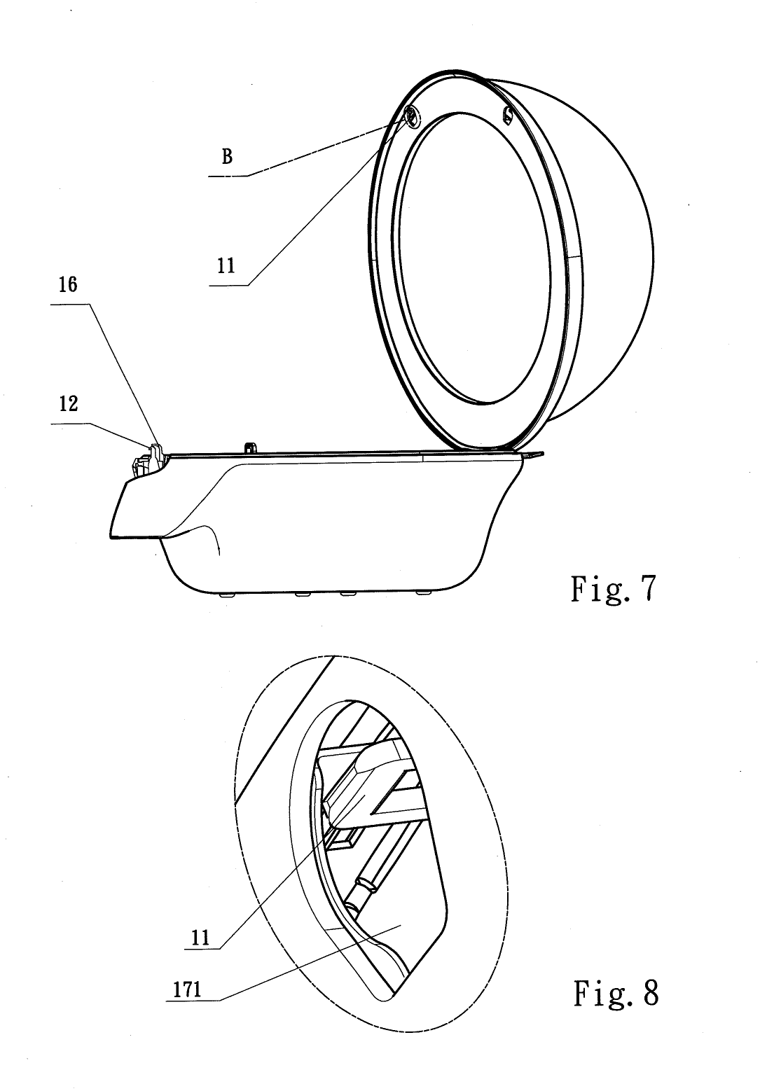

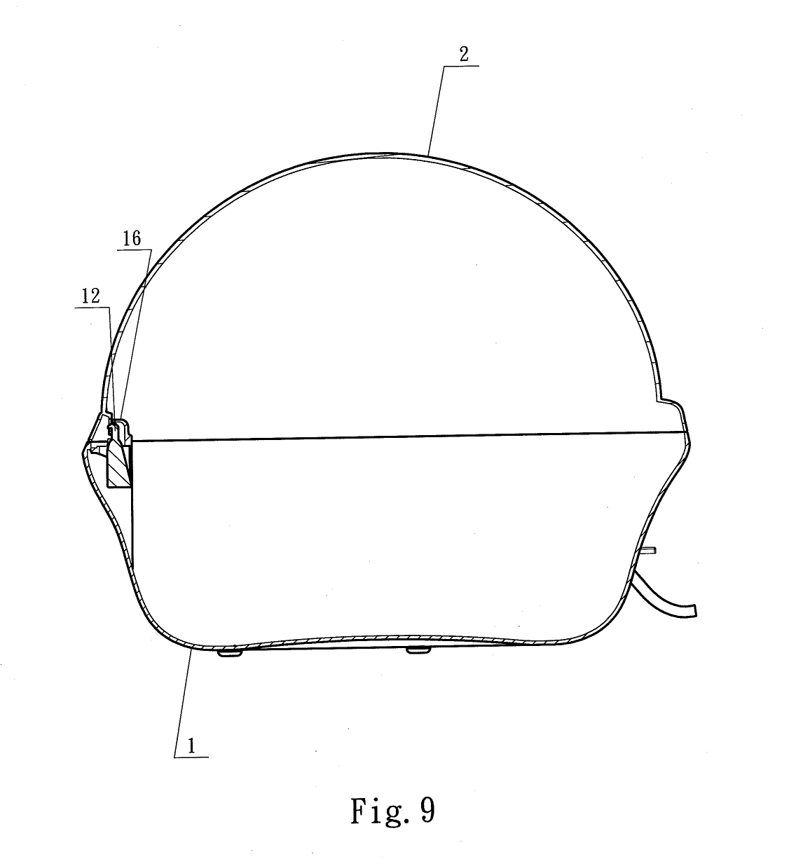

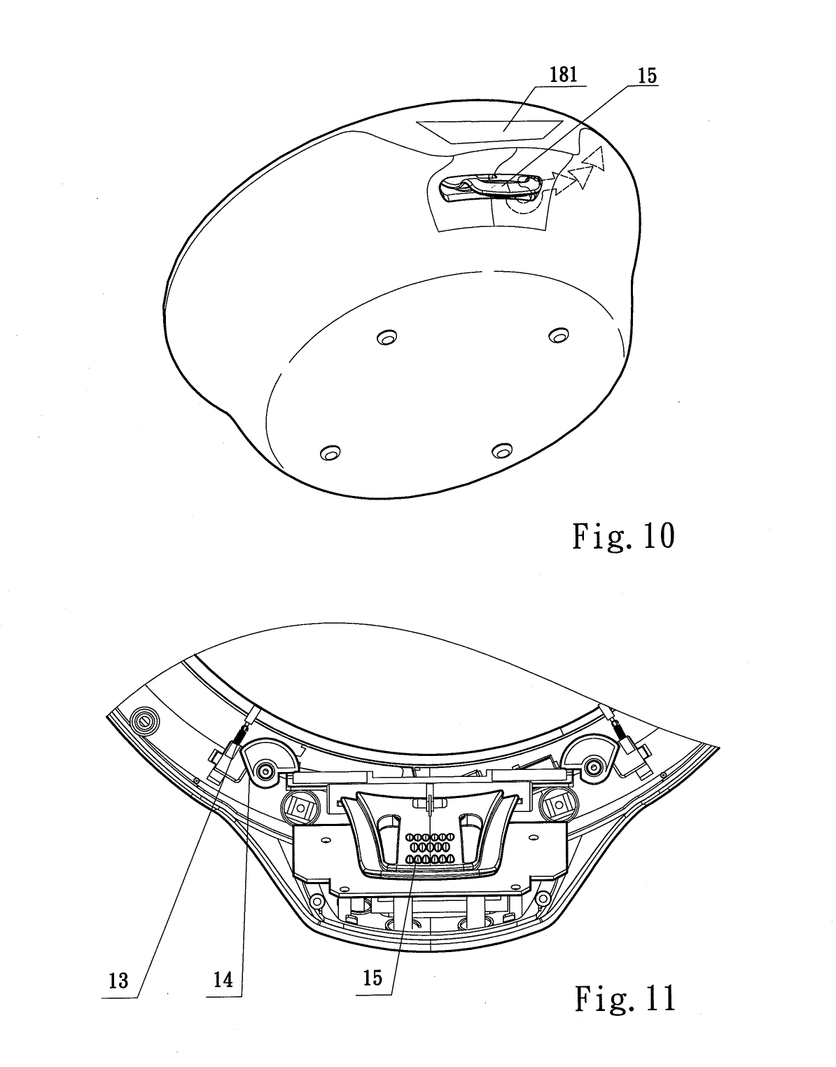

Refer to FIGS. 1 through 11, the present invention aims to provides a microwave oven which includes an oven seat 1, an oven cover 2 hinged on the oven seat, a cooking chamber 3 enclosed by the oven seat 1 and oven cover 2, and also a microwave generation unit, a control unit, and an operation unit. The oven cover 2 can be opened or closed against the oven seat 1 in an up and down manner. The oven cover 2 includes, in this order from an inner side to an outer side, a waterproof cover 4, a microwave shielding cover 5 and an outer cover 6 that are formed respectively in a hemispherical shape and assembled together through an oven cover skeleton 7 and a skeleton frame 8. The waterproof cover 4 and outer cover 6 are transparent and made of a non-metal material. The oven cover skeleton 7 is closely coupled with the waterproof cover 4 and microwave shielding cover 5. The skeleton frame 8 and oven cover skeleton 7 and outer cover 6 are closely coupled together. To facilitate aesthetic appeal of the oven cover 2, it has a shielding plate 17 embedded in an outer side of the oven cover skeleton 7. The shielding plate 17 is formed in an annular shape.

The oven cover skeleton 7 includes an annular base body 72 with an assembly groove 71 on an inner side to allow the waterproof cover 4 to be wedged therein. The microwave shielding cover 5 is pressed on the base body 72. The waterproof cover 4 has a first flange 41 on the outer rim thereof to be wedged in the assembly groove 71. The microwave shielding cover 5 has a second flange 51 on the outer rim thereof to be pressed on the base body 72. The second flange 51 of the microwave shielding cover 5 is coupled by a compressed ring 10 which allows the second flange 51 to be tightly fastened to the oven cover skeleton 7 through screws. The base body 72 also has at least one choke groove 9 on an outer side.

The skeleton frame 8 is coupled on the outer side of the microwave shielding cover 5 and pressed on the second flange 51 and oven cover skeleton 7. The skeleton frame 8 has an annular holding groove 81 wedged by the outer rim of the outer cover 6.

The oven seat 1 and oven cover 2 are latched by at least one door lock mechanism which includes a latch bolt 11, a latch hook 12, a spring 13, a press blade 14 and a door lock pushbutton 15 installed on the oven seat 1. The latch bolt 11 is located on the oven cover skeleton 7. The latch hook 12 has one end extended outwards from an upper end surface of the oven seat 1 to engage with or escape from the latch bolt 11, and another end connected to the spring 13 fastened to the oven seat 1. The press blade 14 is hinged on the oven seat 1 and has two ends connected respectively to the latch hook 12 and door lock pushbutton 15, referring to FIGS. 6, 7, 10 and 11.

The shielding plate 17 has a latch hole 171 corresponding to the latch bolt 11. The oven seat 1 also has a control panel 181 located on a flange 18 at one side thereof. The door lock pushbutton 15 is located on one side of the control panel 181. In this embodiment the door lock pushbutton 15 is located at a lower side of the control panel 181, but also can be located on the left side, right side or upper side according to requirements.

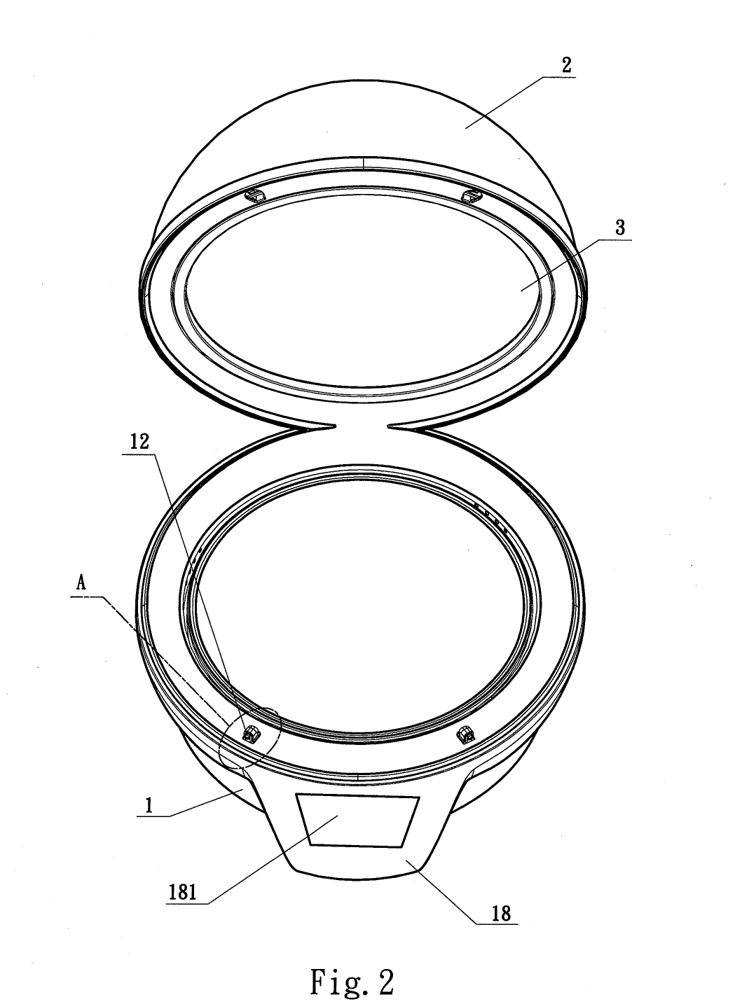

The oven seat 1 further has at least one protective cover 16. The latch hook 12 is located in the protective cover 16 as shown in FIGS. 2 and 6. The protective cover 16 can prevent the latch hook 12 from deformation or loosening off when subject to external forces to enhance safety.

In this embodiment, two or more latch hooks 12 are provided at the front side of the oven seat 1 and incorporated with the hinge between the oven seat 1 and over cover 2 to form three-point support to enhance stability of movement and closing of the oven cover 2.

The oven cover 2 also has a gas discharge port to discharge vapor generated during cooking and resolve safety concern caused by too much pressure formed in the cooking chamber.

The control panel 181 and door lock pushbutton 15 are located on the outer surface of the oven seat 1. The control panel 181 is located on the flange 18 of the oven seat 1, while the door lock pushbutton 15 is located below the control panel 181.

When the oven cover 2 is closed, it is latched tightly via the latch hook 12. During closing of the oven cover 2, the latch hook 12 is receded via the latch bolt 11 so that the oven cover 2 can be pressed down smoothly until reaching to the lowest location. And then the latch hook 12 can be returned to its original position to engage with the latch bolt 11 in the oven cover 2. Next the oven cover 2 is needed to be pulled tightly to prevent it from escaping to achieve secure coupling and enhance safety. For opening the oven cover 2, the door lock pushbutton 15 below the control panel 181 is pushed manually; through an internal transmission mechanism such as gear transmission mechanism, linkage bar transmission mechanism, screw transmission mechanism, chain or belt transmission mechanism, the oven cover 2 can be opened automatically. As the door lock pushbutton 15 is concealed below the control panel 181, it does not spoil the total profile coordination of the entire microwave oven.

What is claimed is:

1. A microwave oven, comprising an oven seat, an oven cover hinged on the oven seat, and a cooking chamber enclosed by the oven seat and the oven cover, wherein the oven cover includes, in this order from an inner side to an outer side, a waterproof cover, a microwave shielding cover and an outer cover that are formed respectively in a hemispherical shape and assembled together through an oven cover skeleton and a skeleton frame.

2. The microwave oven of claim 1, wherein the oven cover skeleton includes an annular base body with an assembly groove on an inner side to allow the waterproof cover to be wedged therein, the microwave shielding cover being pressed on the base body.

3. The microwave oven of claim 2, wherein the waterproof cover includes a first flange on an outer rim thereof to be wedged in the assembly groove, the microwave shielding cover including a second flange on an outer rim thereof to be pressed on the base body.

4. The microwave oven of claim 3, wherein the skeleton frame is coupled on an outer side of the microwave shielding cover and pressed on the second flange and the oven cover skeleton.

5. The microwave oven of claim 1, wherein the skeleton frame includes an annular holding groove wedged by an outer rim of the outer cover.

6. The microwave oven of claim 4, wherein the skeleton frame includes an annular holding groove wedged by an outer rim of the outer cover.

7. The microwave oven of claim 3, wherein the second flange of the microwave shielding cover is coupled by a compressed ring which allows the second flange to be tightly fastened to the oven cover skeleton through screws.

8. The microwave oven of claim 4, wherein the second flange of the microwave shielding cover is coupled by a compressed ring which allows the second flange to be tightly fastened to the oven cover skeleton through screws.

9. The microwave oven of claim 2, wherein the base body of the oven cover skeleton includes at least one choke groove on an outer side thereof.

10. The microwave oven of claim 4, wherein the base body of the oven cover skeleton includes at least one choke groove on an outer side thereof.

11. The microwave oven of claim 1, wherein the oven cover includes a shielding plate embedded in an outer side of the oven cover skeleton.

12. The microwave oven of claim 1, wherein the oven seat and the oven cover are latched by at least one door lock mechanism which includes a latch bolt, a latch hook, a spring, a press blade and a door lock pushbutton installed on the oven seat, the latch bolt being located on the oven cover skeleton, the latch hook including one end extended outwards from an upper end surface of the oven seat and another end connected to the spring fastened to the oven seat, the press blade being hinged on the oven seat and including two ends connected respectively to the latch hook and the door lock pushbutton.

13. The microwave oven of claim 11, wherein the oven seat and the oven cover are latched by at least one door lock mechanism which includes a latch bolt, a latch hook, a spring, a press blade and a door lock pushbutton installed on the oven seat, the latch bolt being located on the oven cover skeleton, the latch hook including one end extended outwards from an upper end surface of the oven seat and another end connected to the spring fastened to the oven seat, the press blade being hinged on the oven seat and including two ends connected respectively to the latch hook and the door lock pushbutton.

14. The microwave oven of claim 9, wherein the waterproof cover and the outer cover are transparent and made of a non-metal material, the shielding plate including a latch hole corresponding to the latch bolt, the oven seat including a control panel on a flange at one side thereof, the door lock pushbutton being located at a lateral side of the control panel, the oven seat further including at least one protective cover, and the latch hook being located in the protective cover.
